(19) United States
(12) Patent Application Publication
(10) Pub. No.: US 2004/0238040 A1
(43) Pub. Date: Dec. 2, 2004

(54) Gas chromatograph

(75) Inventor: Masanao Furukawa, Takaishi-shi (JP)

Correspondence Address: KANESAKA AND TAKEUCHI, 1423 Powhatan Street, Alexandria, VA, 22314, US

(73) Assignee: SHIMADZU CORPORATION

(21) Appl. No.: 10/827,281

(22) Filed: Apr. 20, 2004

(30) Foreign Application Priority Data
May 28, 2003 (JP) 2003-150207

(51) Int. Cl. G05D 7/06

(52) U.S. Cl. 137/487.5

(57) ABSTRACT

A gas chromatograph is with a fluid control assembly for controlling flow and pressure of gas. The fluid control assembly includes a flow path, a control valve situated in the flow path and being capable of adjusting an opening degree thereof, a flow resistance provided in the flow path at a downstream side of the control valve, a differential pressure detecting device for detecting a differential pressure between two ends of the flow resistance, and a pressure detecting device for detecting pressure on an upstream side or a downstream side of the flow resistance. A control device carries out a predetermined calculation based on signals from the differential pressure detecting device and the pressure detecting device for controlling the opening degree of the control valve based on a result of the calculation. Thus, the fluid control assembly is applicable to either flow control or pressure control.

### BACKGROUND OF THE INVENTION AND RELATED ART STATEMENT

The present invention relates to a gas chromatograph, especially gas chromatograph with a fluid control assembly which controls flow or pressure of analysis required gas.

In a conventional gas chromatograph, a control valve for adjusting flow of gas is provided in a supply channel of a carrier gas, for example Japanese Patent Publication (KOKAI) No. 9-15222.

A specific structure of the conventional art is shown in FIG. 4. In FIG. 4, the carrier gas flows to a sample introducing part 17 and a separation column 18 through a supply channel or path 13 from a bomb 1 which is a supply source. In the supply channel 13 of the carrier gas, there are provided, from the upstream side in order, a control valve 16 for adjusting the flow of the carrier gas, a flow resistance 14 for providing moderate pressure drop to the carrier gas, and a differential pressure sensor 15 for detecting a differential pressure between both ends of the flow resistance 14. Additionally, at the downstream of the sample introducing part 17, there is provided a pressure sensor 19 for detecting the inner pressure.

The sample introducing part 17 receives a sample to be analyzed and the separate column 18 carries out separation of constituents into the sample. The detailed explanations of these means are omitted since there is no special need to explain the present invention.

In the structure in FIG. 4, it is noted that flow F of the carrier gas flowing through the supply channel 13 can be calculated by the following formula.

F=K×p1×Δpⁿ (1)

=K×(p3+Δp)×Δpⁿ (2)

In the formulas (1) and (2), Δp stands for a pressure difference between both ends of the flow resistance 14; p1 stands for a pressure of the upstream side of the flow resistance 14; p3 stands for an inner pressure of the sample introducing part 17; n stands for a constant of approximately 0.5˜1; and K stands for a proportional constant determined by the flow resistance 14.

A control portion 10 including a computer carries out the calculation of formula (2) for values of Δp and p3 entered respectively from the differential pressure sensor 15 and the pressure sensor 19 to obtain value of the flow F. By adjusting the valve of the control valve 16 in such a way that the value F becomes a predetermined value, flow of the carrier gas is controlled.

The gas chromatograph can be configured as a fluid control assembly made a flow control part compactly formed of the above-described flow resistance 14, the differential pressure sensor 15, the control valve 16, and the like. By forming the assembly, productivity is increased. Additionally, when the gas chromatograph is broken, it can be quickly fixed by changing the assembly, so that the maintenance is improved as well.

In many cases, the carrier gas in the gas chromatograph is controlled by the flow control which maintains the flow at a predetermined value as mentioned above. However, depending on the analytical content, a pressure control for maintaining a pressure at a predetermined value may be required. Also, in many cases, the gas other than the carrier gas used in the gas chromatograph is controlled by the pressure control. However, since the conventional fluid control assembly has been made to control only one of the flow or the pressure, it was required to use different assemblies according to a purpose.

The present invention has been made in view of the above-described situation, and an object of the present invention is to provide a widely applicable fluid control assembly applicable to either flow control or pressure control for the same assembly, to thereby provide a gas chromatograph with better productivity and maintenance than ever before.

Further objects and advantages of the invention will be apparent from the following description of the invention.

### SUMMARY OF INVENTION

In order to solve the above-described problem, in the present invention, a gas chromatograph is provided with a fluid control assembly. The fluid control assembly comprises a control valve adjustable in its opening ratio; a flow resistance provided in the downstream side; differential pressure detecting means for detecting a differential pressure between both ends of the flow resistance; pressure detecting means for detecting pressure on the upstream side or downstream side of the flow resistance; and control means for carrying out a predetermined operation based on signals from the differential pressure detecting means and the pressure detecting means, and controlling the valve opening degree of the control valve by the result of the calculation.

With the above-mentioned structure, a widely applicable fluid control assembly can be obtained, and the gas chromatograph with the fluid control assembly leads to better productivity and maintenance.

### BRIEF DESCRIPTION OF THE DRAWINGS

FIG. 1 is a block diagram showing an embodiment of the present invention;

FIG. 2 is a block diagram showing another embodiment of the present invention;

FIG. 3 is a block diagram showing a still further embodiment of the present invention; and

FIG. 4 is a block diagram showing a conventional structure.

### DETAILED DESCRIPTION OF PREFERRED EMBODIMENTS

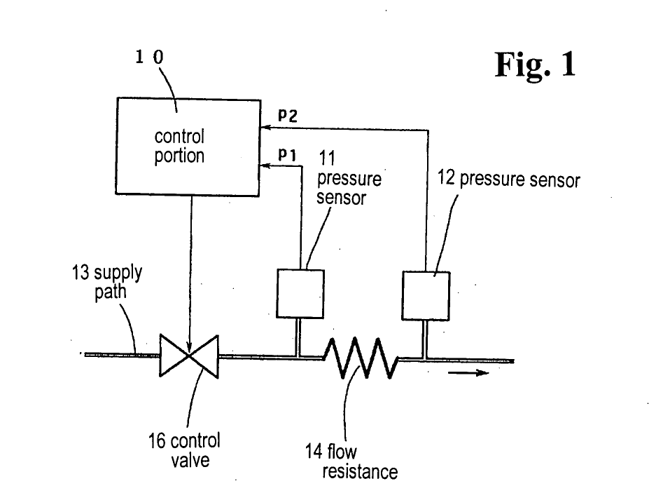

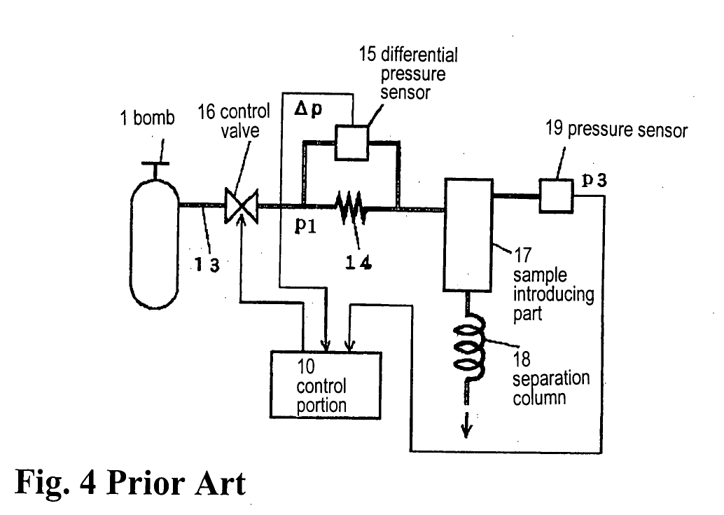

An embodiment of the present invention is shown in FIG. 1. This figure shows a structure as the fluid control assembly, and in the gas chromatograph, for example, when it is used for controlling the carrier gas, in the same way as shown in FIG. 4, the bomb which is a supply source of the carrier gas is connected to an upstream side (left side in FIG. 1) and also, the sample introducing part and the separate column are connected to the downstream side (right side in FIG. 1).

In FIG. 1, numerical symbols 11, 12 represent pressure sensors for detecting the gas pressures which are the objects to be controlled. In FIG. 1, explanations of numerical symbols similar to those already explained are omitted.

In the drawings, the carrier gas or other gas (hereinafter collectively referred to as analysis required gas) which becomes the control object flows from the supply channel or path 13 through the control valve 16 and the flow resistance 14 in a left-to-right direction, and there produces the differential pressure Δp between the both ends. When output signals of the two pressure sensors 11, 12 are p1, p2 respectively,

Δp=p1−p2 (3)

Therefore, formula (1) can be rewritten as stated below.

F=K×p1×(p1−p2)ⁿ (4)

When the flow control is carried out by the fluid control assembly in FIG. 1, an operation of the formula (4) is carried out in the control portion 10 using values of p1, p2 derived from the two pressure sensors 11, 12, and then, the opening degree of the control valve 16 is adjusted in such a way that the value of F derived from the result of the operation becomes a predetermined value. On the other hand, when the pressure control is carried out, the signal p1 from the pressure sensor 11 may not be taken, and the opening degree of the control valve 16 may be adjusted in such a way that the value p2 becomes a predetermined value. Specifically, by using the fluid control assembly configured as shown in FIG. 1, it can be applicable to both the fluid control and the pressure control.

In addition, the two pressure sensors 11, 12 here are independent pressure detecting means respectively. However, the two pressure sensors 11, 12 can be considered as differential pressure detecting means altogether since they are used for finding a differential pressure by the formula (3).

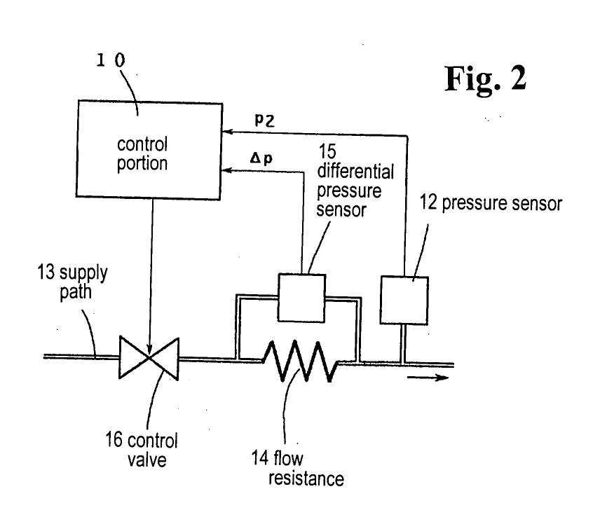

FIG. 2 shows another embodiment of the present invention. In FIG. 2, the numerical symbol 15 represents the same differential pressure sensor as the differential pressure sensor in FIG. 4, and all the other same numerical symbols in FIG. 2 as those in FIG. 1 represent the same numerical symbols in FIG. 1. Since there is almost no pressure drop between the downstream side of the flow resistance 14 and the inlet side of the separate column 18 in FIG. 4, p3 in FIG. 4 and p2 in FIG. 2 can be regarded as about the same, so that the flow F of the analysis required gas supplied from the supply channel 13 in FIG. 2 is formularized with the following formula, wherein p3 in formula (2) is replaced with p2.

F=K×(p2+Δp)×Δpⁿ (5)

Therefore, flow control can be carried out by carrying out an operation of the formula (5) by the control portion 10, and then adjusting the opening degree of the control valve 16 in such a way that the value of F derived from the result of the operation becomes a predetermined value. Also, regarding the pressure control, as in the case of FIG. 1, the signal Δp from the differential pressure sensor 15 may not be taken, and the valve travel of the control valve 16 may be adjusted in such a way that the value of p2 becomes a predetermined value.

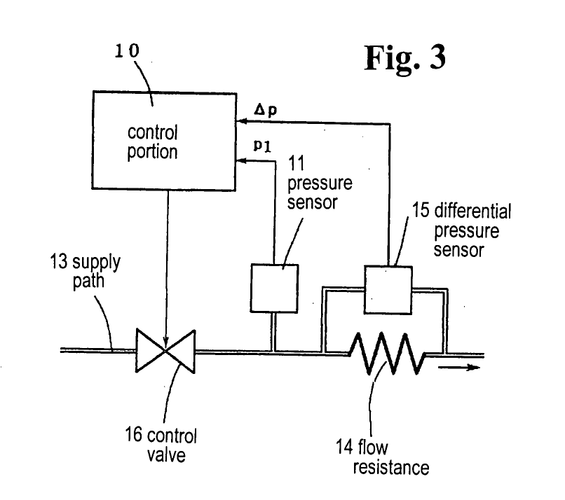

FIG. 3 shows a further embodiment of the present invention. A difference between FIG. 2 and FIG. 3 is that the pressure sensor 11 is provided on the upstream side of the flow resistance 14 in FIG. 3. The flow F in FIG. 3 can be represented by the formula (1). Therefore, by adjusting the opening degree of the control valve 16 in such a way of keeping the value F derived from the result of the operation with formula (1) in a predetermined value, the flow control can be carried out. Also, by keeping p1-Δp in a predetermined value, the pressure control can be carried out.

In addition, the above-explained pressure sensor and differential pressure sensor can be replaced by the other pressure detecting means and differential pressure detecting means. Incidentally, the above-mentioned examples are examples of the present invention, so that the present invention is not limited to the embodiments described hereinabove.

Substantially as described above, the fluid control assembly of the present invention can be applied to either flow control or pressure control and is widely applicable, so that the gas chromatograph can be provided with better productivity and maintenance than ever before.

While the invention has been explained with reference to the specific embodiments of the invention, the explanation is illustrative and the invention is limited to the appended claims.

What is claimed is:

1. A gas chromatograph with a fluid control assembly for controlling flow and pressure of gas, said fluid control assembly comprising:
a flow path,
a control valve situated in the flow path and being capable of adjusting an opening degree thereof,
a flow resistance provided in the flow path at a downstream side of the control valve,
differential pressure detecting means attached to the flow path for detecting a differential pressure between two ends of the flow resistance,
pressure detecting means attached to the flow path for detecting pressure on an upstream side or a downstream side of the flow resistance, and
control means attached to the control valve, differential pressure detecting means and pressure detecting means for carrying out a predetermined calculation based on signals from the differential pressure detecting means and the pressure detecting means for controlling the opening degree of the control valve based on a result of the calculation.

2. A gas chromatograph according to claim 1, wherein said differential pressure detecting means is a pressure sensor, and said pressure detecting means is a pressure sensor, said pressure sensors being attached to the upstream side and the downstream side of the flow resistance.

3. A gas chromatograph according to claim 1, further comprising a bomb for providing a fluid to the flow path, and a sample introducing part, said fluid control assembly being situated between the bomb and the sample introducing part.
